(19) United States
(12) Patent Application Publication
(10) Pub. No.: US 2009/0150594 A1
(43) Pub. Date: Jun. 11, 2009

(54) METHOD TO MINIMIZE FLASH WRITES ACROSS A RESET

(76) Inventors: Michael A. Rothman, Puyallup, WA (US); Vincent J. Zimmer, Federal Way, WA (US)

Correspondence Address: INTEL CORPORATION;c/o CPA Global, P.O. BOX 52050, MINNEAPOLIS, MN, 55402, US

(21) Appl. No.: 11/864,541

(22) Filed: Sep. 28, 2007

(51) Int. Cl. G06F 12/00; G06F 15/177; G06F 12/02

(52) U.S. Cl. 711/103; 713/2; 711/E12.008; 711/E12.001

(57) ABSTRACT

A method and apparatus described herein are for minimizing flash writes across reset. When a commonly accessed variable is to be updated, an erase conscious value is written to minimize erase operations. As an example, the location for the commonly accessed variable holds consecutive values to represent a usable value instead of a binary representation. Furthermore, when the commonly accessed variable is to be read, the stored value is translated into the associated usable value for use by a system.

### FIELD

This invention relates to the field of computer systems and, in particular, to ensuring stability of data held in memory.

### BACKGROUND

Computer system configurations have evolved from pure personal computing uses into a completely new realm of media and entertainment. As a result, numerous different peripheral devices have been designed for computing systems. A few examples of these peripheral devices include graphics accelerator cards for faster video gaming, tuner cards for watching TV, audio cards for better music/sound quality, and networking cards for enabling fast and potentially wireless internet connection. Previously, legacy drivers in basic input/output software (BIOS) were used to handle computer add-in devices. However, as the devices have increased in complexity and in number the boot code for these devices becomes larger and more complex.

In conjunction, upon a re-boot of computer system, boot memory may be updated even when configuration settings have not been altered by the user. However, boot memory, such as flash memory to hold Basic Input/Output Software (BIOS) code or Extensible Firmware Interface (EFI) code has a maximum number of write/erase cycles. For example, a NOR or NAND flash device may be roughly limited to 100,000 write/erase cycles. As a result, when information held in a particular area of a flash device is commonly updated in response to a reboot, the sector or area holding that information may lead to corrupted/failed data. In other words, holes may be worn into non-volatile memory where commonly updated variables are held. If the corrupted information is critical to boot or operation of the system, then corruption thereof potentially leads to instability or inoperability of the system.

To illustrate, FIG. 1 depicts a prior art method of updating boot variables. Flash memory device 105 includes main array 107 to hold information, such as boot variables 110. An example of a boot variable is a monotonic count variable (MCV) to be incremented upon every reboot. Essentially, at least a portion of the MCV keeps a count of how many times the system including flash memory 105 has been booted. Here, values of the MCV are illustrated through values 111-114, which are represented as binary values. As illustrated, MCV is updated from binary value 111, which represents a decimal value of one, to a binary value 112. Here, the least significant bit is changed from a logical one to a logical zero. Often, in a flash device the updating of a bit from a one to a zero requires an erase operation. As binary value 112 is updated to value 113 and binary value 114, the least significant bit undergoes another erase operation. As discussed above, holes may be worn in main array 107 as parts of MCV are repeatedly erased.

### BRIEF DESCRIPTION OF THE DRAWINGS

The present invention is illustrated by way of example and not intended to be limited by the figures of the accompanying drawings.

FIG. 1 illustrates an embodiment of a prior art method updating a boot variable in a flash device.

FIG. 2 illustrates an embodiment of a non-volatile memory device including logic capable of writing values biased towards minimizing erase operations.

FIG. 3 illustrates an embodiment of a method of updating a boot variable to minimize erase operations.

FIG. 4 illustrates an embodiment of a flow diagram for a method of minimizing erase operations in updating commonly accessed variables held in a non-volatile memory.

### DETAILED DESCRIPTION

In the following description, numerous specific details are set forth such as examples of specific non-volatile memory devices, translation algorithms, and commonly accessed variables etc. in order to provide a thorough understanding of the present invention. It will be apparent, however, to one skilled in the art that these specific details need not be employed to practice the present invention. In other instances, well known components or methods, such as specific flash device architecture/operation, specific logic gates, and specific boot processes/methods have not been described in detail in order to avoid unnecessarily obscuring the present invention.

The method and apparatus described herein are for minimizing writes during updates to non-volatile memory. Specifically, minimizing writes is primarily discussed in reference to flash memory devices holding boot code, such as commonly updated boot variables. However, the methods and apparatus described herein are not so limited, as they may be implemented on or in association with any memory device, as well as in conjunction with any type code or information to be held therein.

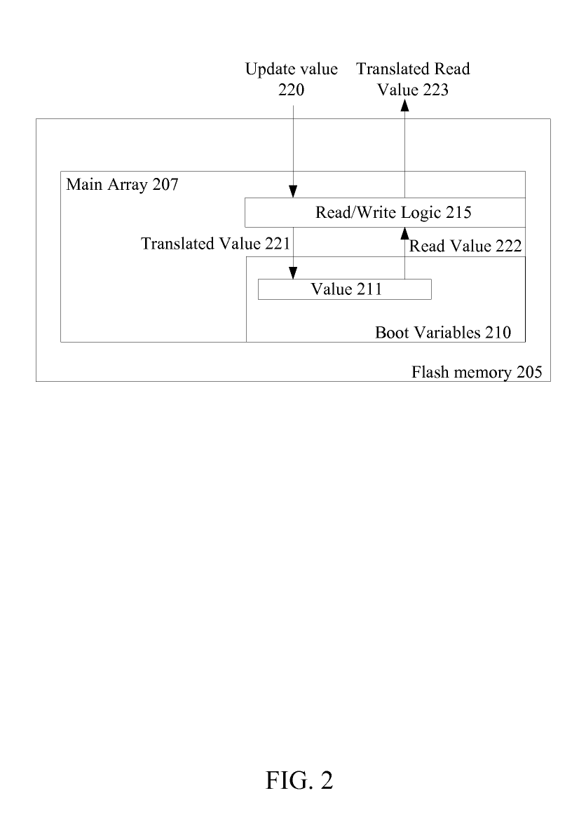

Referring to FIG. 2, an embodiment of a non-volatile memory capable of minimizing erase operations is illustrated. Non-volatile (NV) memory 205 is typically a memory that retains stored information after power is removed; however, NV memory 205 may be any memory including a memory array and logic/buffer to write to the memory array. Furthermore, memory 205 may hold both non-volatile and volatile information. Memory device 205 may be a static random access memory (SRAM), a dynamic random access memory (DRAM), an electrically programmable read-only memory (EPROM), an electrically erasable programmable read only memory (EEPROM), a phase change memory or a flash device.

As a specific example, memory device 205 is an erasable programmable read-only memory (EPROM). An EPROM and an electrically erasable PROM, or EEPROM device, is often referred to as a flash device, since the device is “flashed” or electrically erased/programmed.

The two common types of flash memory include NOR and NAND flash memory, which refers to the types of transistors used in the device. Both types of flash memory store information in an array of transistors, which are referred to as cells. Traditionally, each storage cell is to hold 1-bit of information per cell; however, multi-bit or multi-level cells are also currently used to hold multiple bits or logical levels per storage cell of a flash device.

A non-volatile memory device, such as device 205, typically includes an array, such as main array 207, to hold data, code, elements, logical values, boot variables, and other information. Main array 207 may be physically or logically organized in any manner including a single dimensional array, a multiple dimensional array, or a plurality of random memory elements, as well as being physically partitioned or virtually partitioned to use different parts of one array for multiple uses or features.

In one embodiment, memory 205 is a flash device, where main array 207 is organized into blocks, segments, and/or sectors. Older implementations of flash devices required erasure of the whole flash device for programming. Since this was inefficient in frequently updated flash devices, a block organization became common to allow erasure on a block-level.

As an example, assume memory 205 is a NOR flash device. A NOR flash cell is typically set to a specified data value by starting up electrons flowing from the source to the drain and applying a large voltage placed on a control gate, which provides a strong enough electric field to accumulate the electrons on a floating gate, a process called hot-electron injection.

To erase a NOR flash cell, which is commonly done by resetting a cell, a large voltage differential is placed between the control gate and source, which pulls electrons off the floating gate. Most modern main memory arrays in flash devices are divided into erase segments, usually called either blocks, segments or sectors. Through operation of the erase procedure, a full block, segment or sector is erased. NOR programming, however, can generally be performed one byte or word at a time. NAND flash devices work on similar principles and are also often organized in sectors, segments or blocks. The specific implementations, operation, and manufacture of NOR and NAND flash is not described herein in detail to avoid obscuring the invention, as both types of flash are extremely well-known in the art.

Often, the use of logic levels or logical values is also referred to as 1's and 0's, which simply represents binary logic states. For example, a 1 refers to a high logic level and 0 refers to a low logic level. In many older systems a high voltage level was represented by a voltage, e.g. 5V, and a low voltage level, e.g. 0V. As another specific example, a high logic level is at 1.2V and a low logic level is at 0.3V. However, a high logic/voltage level may refer to any voltage level above a threshold value, and inversely, a low logic level may refer to any voltage level below the threshold value. In addition, there may be more than two logical levels in a cell or waveform. As an example, a single cell may hold four different logical values at different voltage levels.

As illustrated, a portion of main array 207 is to hold commonly accessed variables. Examples of commonly accessed variables include boot variables accessed in response to a reset or other system event. However, a commonly accessed variable may include any variable frequently accessed, which potentially results in frequent flashing of specific bits/blocks, as discussed above. Also note, that commonly accessed variables 210 are illustrated in a single area/portion of main array 207; however, they may be distributed through out main array 207.

Here, commonly accessed value 211 is utilized to illustrate operation of minimizing flash writes. In one embodiment, value 211 is a count variable to hold a representation of a number of times a system including memory 205 has been booted. The count variable may sometimes be referred to as a monotonic count variable (MCV). In fact, a MCV potentially includes one volatile portion to keep track of a number of times the MCV is accessed during current operation of the system and a non-volatile portion to keep track of a number of times the system has been rebooted.

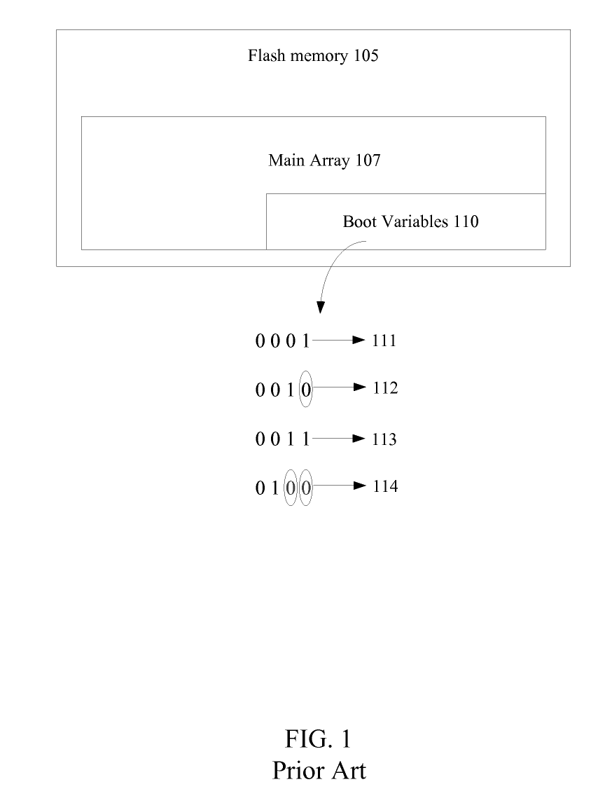

As an example, a reboot event occurs. In response to the reboot, value 211 is to be updated to represent another boot of the system has occurred. Value 211 may be incremented in any manner; however, often an integer count is kept. Therefore, upon a first boot of the system, a zero value is held in count variable 211 to indicate the system has not been booted. Responsive to the boot, value 211 is to be updated to indicate one boot of the system has occurred. Previously, as discussed in reference to FIG. 1, a binary representation of the zero value would be updated to a binary representation of a one, and so on as the count increments.

However, in one embodiment, MCV 211 is to be incremented to an updated value 220, such as the integer value of a greater value then the current value held in MCV 211. Here, a write command or other request may initiate a write within the flash device to MCV 211. Often, write logic in a flash memory consists of a write buffer, which potentially updates single or multiple words in response to a write-to-buffer command. Note, update value 220 may not be included within the update/write request to flash 205, but rather an increment command may be received. Here, update value 220 represents an incremented version of a current value held in MCV 211.

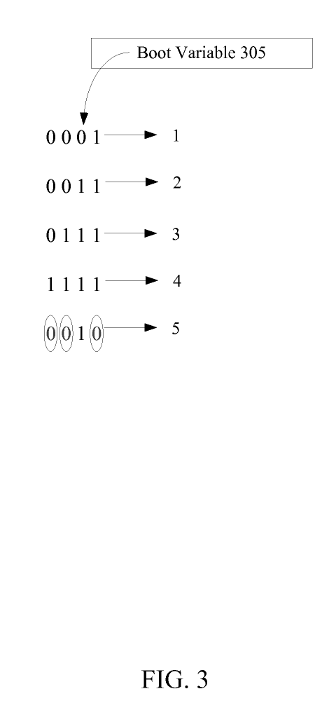

Read/write logic 215, in one embodiment, instead of writing update value 220, writes translated value 221, which is an erase conscious value, to MCV 211. Note that any known translation method or translation algorithm may be used to translate update value 220 to erase conscious value 221. An erase conscious value refers to a value that is to minimize erase, flash, or reclaim operations in updating values in memory 205. The minimization of erase, flash, and or reclaim operations may be measured within a single update or over multiple updates, which is discussed in more detail below in reference to FIG. 3.

As stated above, erase conscious value 221 is translated and/or associated with update value 220. Furthermore, MCV 211 holds translated value 221, which may not be correct information from a binary view of the data from the perspective of the system. In fact, the correct value from a system's perspective is update value 220. Therefore, in response to a read request to read/load MCV 211, read/write logic 215, in one embodiment, translates the currently held erase conscious value, i.e. read value 222, to translated read value 223, i.e. update value 220, based on the same translation method or algorithm for translating update value 220 to erase conscious value 221. Essentially, a value to minimize erase and/or flash operations is held in MCV 211; however, the value may not be a correct binary representation of the current boot count. Instead, the value may be translated through a predetermined algorithm within read/write logic 215 on a read to obtain the correct current boot count. Therefore, the translation is transparent to an external requestor/system, as the system/requestor receives a correct decimal/binary boot count upon a read request. Yet, the actual value held in MCV 211 is an erase conscious value to minimize erase, flash, and reclaim operations leading to longevity of memory 205.

Turning to FIG. 3 an embodiment of a translation method or algorithm to minimize erase/flash operations is illustrated. Often, in a flash device, setting storage cells to a logical high value, such as a logical one, may be done on a cell-by-cell basis and does not require an erase operation, while returning a storage cell to zero requires a flash/erasure of a block including the storage cell. However, even though, erasure and/or flash of a block/storage cell is depicted with circles around bits flipped from a logical high value of one to a logical low value of zero in FIG. 3, minimizing erase and flash operations is not so limited. In fact, often in some flash devices a default value is a logical one. Therefore, an erase or flash operation may include returning a storage cell or block of storage cells to a logical one from a logical zero, while bits may be individually set to a logical zero on a cell-by-cell basis without erasure.

Here, boot variable 305 is to be held in a non-volatile memory, such as a flash memory device. In one embodiment, writing an erase conscious value includes setting consecutive storage cells to a first logical value, instead of a correct binary representation. As a simplified illustrative example, assume boot variable 305 is an MCV to indicate a number of times a system has been booted. In response to a first boot of the system, MCV 305 is to be updated to a decimal integer of one. Being that a current binary value of 0000 is held in boot variable 305, the least significant bit (LSB) of MCV 305 may be set to a logical one without an erase operation at update 310. Here, both the erase conscious value and the binary value are the same. Therefore, upon read out of boot variable 305 after update 310, a binary value of 0001 is provided.

However, when the system is rebooted, MCV 305 is to be updated to a decimal value of two from the system's perspective. However, an update of binary value 0001 to 0010 potentially includes an erase of the LSB. Therefore, the block containing the LSB would be flashed and the second LSB would be set to a one. Therefore, read/write logic, in one embodiment, instead sets the second LSB to a consecutive logical one in update 315. Here, a simple count of the number of consecutive logical ones yields a correct representation of MCV 305, i.e. two consecutive logical ones leads to a decimal MCV value of two. As can be seen, upon each subsequent update 320 and 325 of MCV 305, which may be in response to subsequent boots, another consecutive more significant bit is set.

In other words, a logical one is appended to the consecutive logical ones. Here, when a value is read out after update 320, the three consecutive LSBs are set to a logical one indicating a decimal value of three. Therefore, in response to a read, the erase conscious value of 0111 is translated by read logic to a correct decimal value of three, i.e. 0011, which is then provided to the system. Essentially, the erase conscious value of 0111 is translated to the correct binary value of 0011 based on the algorithm of consecutive logical ones being appended. Note that as illustrated in FIG. 3 logical ones are appended from LSB to MSB. However, appending bits is not so limited, as consecutive logical zeros may be utilized, as well as appending logical values in the opposite direction, i.e. from MSB to LSB.

FIG. 3 is limited to a simplified illustrative example where boot variable 305 includes four storage cells to hold four logical bit values. However, boot variable 305 may have any length, such as any number of cells to hold 32, 64, or 128 logical values. However, in any of the implementations, consecutive bits may be appended until the MSB position is reached, as in update 325. Here, in one embodiment, an offset of a start of the consecutive logical values from a beginning of MCV 305 is also utilized to update/translate an erase conscious value.

As an example, after update 325, MCV 305 holds an erase conscious value of 1111, which represents a decimal value of four and a binary value of 0100. In response to the next update, MCV 305 is flashed/erased and restarted with an offset of one storage cell position, i.e. an erase conscious value of 0010, in update 330. The offset of the starting/first consecutive bit being at the second LSB indicates the erase conscious value represents the maximum value to be held by MCV 305, which in this case is four (1111), plus the current number of consecutive logical values, i.e. plus one, to indicate a decimal number of five. To further illustrate, an erase conscious value of 1110 indicates a decimal value of seven, while an erase conscious value with an offset of two, such as 0100, indicates the maximum of no offset, i.e. four, plus the maximum of one position offset, i.e. three, plus the one current consecutive value to indicate a decimal value of eight.

As stated above, minimizing erase/flash operations may be viewed from a single operation and/or over multiple updates. For example, an update from a decimal value of four, which has a binary value of 0100, to a decimal value of five, which has a binary value of 0101, does not include an erase or flash operation. In contrast, during update 330, the update from decimal value four to five includes a flash/erase operation. However, taken as a whole in comparison to FIG. 1, in the extremely simplified example of incrementing to a decimal value of five, the embodiment illustrated in FIG. 3 includes one less flash/erase operation. Although a translation algorithm including consecutive logical values is illustrated in FIG. 3, any known translation method may be utilized. As an example, read/write logic may include a translation or mapping table, where one column includes a correct decimal/binary count value and the other column includes erase conscious update values. Here, translation between the values may have no correlation other than through the mapping table.

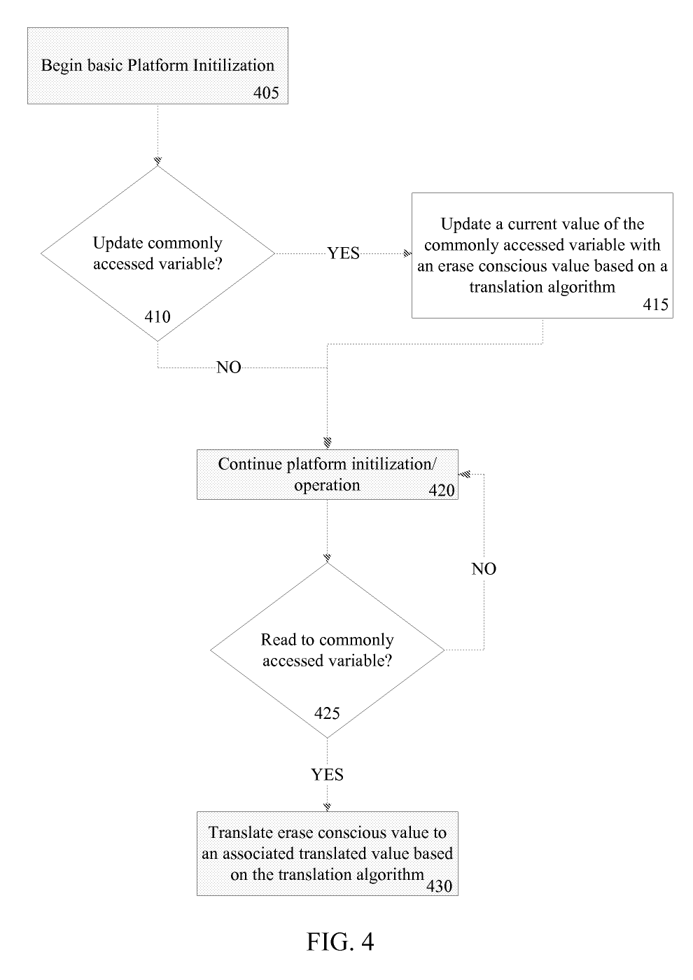

Turning to FIG. 4, an embodiment of a flow diagram for minimizing erase operations is illustrated. In flow 405, basic platform initialization is started. As an example, initialization routines, such as power on self test (POST) are performed. Note that FIG. 4 illustrates an embodiment of minimizing erase operations associated with commonly accessed variables updated during a boot process. However, minimizing erase operations associated with accesses to data/information held in memory may be performed at anytime during operation, such as runtime.

Next, in flow 410, it is determined if a commonly accessed variable is to be updated. As stated above, an example of a commonly accessed variable upon boot is a monotonic count variable (MCV). Often, the MCV is to be incremented in response to every boot of a system. If an update to commonly accessed data, such as an MCV, is to be performed, then in flow 415, a current value of the commonly accessed variable is updated with an erase conscious value based on a translation algorithm.

In one embodiment, the translation algorithm includes any know method of value translation or representation, which reduces erase/flash operations over a number of updates. For example, consecutive logical values may be held to represent an integer count variable. As previously discussed, the number of consecutive values represents the integer number. Furthermore, a position where the consecutive values start in relation to a beginning of the variable may also be utilized in representing an integer count value. In another embodiment, a translation table is utilized to associated erase conscious values with correct integer count values.

Where the memory holding the commonly accessed variable is a flash device, minimizing erase/flash operations may be done by biasing writes against utilizing a specific logical value. For example, in some flash devices, when a storage cell is to be reset from a logical one to a logical zero, the whole block including the storage cell is to be erased/flashed. Therefore, erase conscious values include any values that minimize updating a storage cell from a logical one to a logical zero. Conversely, where flashing is need to flip a logical zero to a logical one, then erase conscious values minimize flipping a storage cell from a logical zero to a logical one.

Therefore, whether an erase conscious value is written to the memory in flow 415, or no update to the commonly accessed variable is to be performed in flow 410, platform initialization continues in flow 420. Whether still booting or during runtime, a requester may request a read/write of the data. If a write command is issued, the similar steps of translating the value to be written to an erase conscious value and updating the memory location with the erase conscious value is repeated.

However, if the requester is requesting a read/load of the variable, then in flow 425 it is determined a read is being requested. Next, in flow 430, the current value of the variable, which may be the previously updated erase conscious value from flow 415 is translated to an associated translated value based on the corresponding algorithm. For example, utilizing the consecutive logical value algorithm, an offset of consecutive values and a number of consecutive values is utilized to derive the correct integer/binary value. Where a mapping table is utilized, the entry with the current erase conscious value is located, and the corresponding/associated integer/binary value is located therein. The correct translated value is then provided to the requestor. Therefore, the translation and minimizing of erase/flash operations is transparent to a requester, as the memory device itself performs the translations.

As can be seen from above, erase and flash operations that are done repetitively to specific memory locations, such as increments of a monotonic boot count variable, may lead to memory failures. In other words, holes may be worn in flash memory through excessive flashing of specific locations. However, by writing erase conscious values that minimize erase/flash operations, the life of a memory may be extended. Furthermore, by integrating the translation within the memory device itself, the translation becomes transparent to a requestor, allowing for a balance of system compatibility with ensuring longevity and reliability of memory.

The embodiments of methods, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a non-volatile memory device to hold a current value, wherein the non-volatile memory device, in response to a request to update the current value, is to update the current value to a next value, wherein the next value is biased towards minimizing erase operations associated with updating the current value to the next value.

2. The apparatus of claim 1, wherein the current value is a count variable to be incremented in response to a boot of a system including the non-volatile memory, and wherein a request to update the current value, includes a reset of the system.

3. The apparatus of claim 1, wherein the current value, when read, is to be translated to a current translated value based on a predetermined translation algorithm, and wherein the next value, when read, is to be translated to a next translated value based on the predetermined translation algorithm.

4. The apparatus of claim 3, wherein the current value, when read, is to be translated to a current translated value based on a predetermined translation algorithm, and wherein the next value, when read, is to be translated to a next translated value based on the predetermined translation algorithm comprises logic to translate the current value, when read, to the current translated value and the next value, when read, to the next translated value based on a number of consecutive bits in the current value, when read, and the next value, when read, holding a high logical value and on an offset of a starting point of the number of consecutive bits from a beginning of the current value, when read, and the next value, when read.

5. The apparatus of claim 3, wherein the non-volatile memory includes a flash memory device.

6. The apparatus of claim 5, wherein the flash memory device to hold the current value comprises a plurality of storage cells in the flash memory device to hold the current value.

7. The apparatus of claim 6, wherein the flash memory device is a NOR flash memory device, and wherein the plurality of storage cells include at least one transistor to store at least one logical bit of information.

8. The apparatus of claim 5, wherein the flash memory device to update the current value to the next value associated with the second value, wherein the next value is biased towards minimizing erase operations associated with updating the current value to the next value comprises: logic in the flash memory device to update the plurality of storage cells in the flash memory device to hold the next value, wherein the logic in the flash memory is to perform less erase operations to update the current value to the next value than to update the current translated value, if held by the plurality of storage cells, to the next translated value.

9. The apparatus of claim 8, wherein the current translated value includes a binary value, and wherein the next translated value includes an incremented binary value of the current translated value.

10. The apparatus of claim 8, wherein the logic in the flash memory device to update the plurality of storage cells in the flash memory device to hold the next value comprises: the logic to write a first logical value to a next storage cell consecutive to a number of consecutive storage cells to hold high logical values for the current value, wherein the next value includes the number of consecutive storage cells to hold high logical values and the high logical value to be held in the next storage cell.

11. A method comprising:
updating a current value held in a non-volatile memory with an erase conscious value, wherein the erase conscious value is based on a translation algorithm to minimize erase operations associated with updating the current value to the erase conscious value; and
translating the erase conscious value to an associated translated value based on the translation algorithm in response to reading the erase conscious value.

12. The apparatus of claim 11, wherein the non-volatile memory includes a flash memory.

13. The apparatus of claim 12, wherein the current value includes a current value of a boot variable to be updated in response to a boot of a system including the flash memory, and wherein updating the current value with the erase conscious value is in response to a boot of the system.

14. The apparatus of claim 12, wherein translating the erase conscious value to the associated translated value based on the translation algorithm comprises:
determining an ending storage cell that holds a last consecutive logical high value in a consecutive number of logical high values within a range of storage cells of the flash memory that is to hold the erase conscious value; and
determining the associated translated value based on a position of the ending storage cell within the range of storage cells.

15. The apparatus of claim 14, wherein translating the erase conscious value to the associated translated value based on the translation algorithm further comprises:
determining an offset of a starting storage cell of the consecutive number of logical high values from a beginning of the range of storage cells;
determining the associated translated value based on the position of the ending storage cell and the offset of the starting storage cell.

16. The method of claim 14, updating a current value held in the flash memory with an erase conscious value, wherein the erase conscious value is based on a translation algorithm to minimize erase operations associated with updating the current value to the erase conscious value comprises appending a logical high value to a next storage cell consecutive with the ending storage cell.
